(19) United States
(12) Patent Application Publication
(10) Pub. No.: US 2026/0093836 A1
(43) Pub. Date: Apr. 2, 2026

(54) UMBRELLA USER CONTEXT DATABASE

(71) Applicant: Wells Fargo Bank, N.A., San Francisco, CA (US)

(72) Inventors: Sean Edward Falese, Jenkintown, PA (US); David Randall Hom, Millbrae, CA (US); Nathanial David Sanders, Papillion, NE (US)

(21) Appl. No.: 18/903,472

(22) Filed: Oct. 1, 2024

(51) Int. Cl. G06F 21/62; G06F 21/60

(52) U.S. Cl. CPC G06F 21/6218; G06F 21/602

(57) ABSTRACT

An example computer system and method for managing and controlling personal data within a digital ecosystem is presented. The computer system includes one or more processors and non-transitory computer-readable storage media. The encoded instructions, when executed by the one or more processors, cause the computer system to: capture data related to interactions of a user with a first business application; encrypt the data and store the data in a data repository; enable the user to view and manage the data repository, including the ability to access, modify, and organize the data; allow the user to set and modify consent for data sharing and permissions for data usage with a second business application; and provide a federated gateway to facilitate secure sharing of the data with the second business application, while ensuring compliance with the permissions for data usage with the second business application.

### BACKGROUND

In the digital age, the proliferation of business applications that interact with user data has led to concerns regarding data privacy and security. As users engage with various digital services, vast amounts of personal data are continuously captured and processed by the services. In many cases, this data includes sensitive information, such as personal identifiers, financial details, and interaction histories. The widespread collection of such data has raised alarm over the potential for unauthorized access, misuse, and data breaches. Many existing services do not provide adequate mechanisms for users to effectively manage their personal data, leaving users vulnerable to privacy violations.

### SUMMARY

Embodiments of the disclosure are directed to managing and controlling personal data within a digital ecosystem. The concept can include one or more processors and non-transitory computer-readable storage media encoding instructions which, when executed by the one or more processors, cause the concept to capture data related to interactions of a user with a first business application, encrypt the data, and store it in a data repository. The concept enables the user to view and manage the data repository, including the ability to access, modify, and organize the data. Additionally, the concept allows the user to set and modify consent for data sharing and permissions for data usage with a second business application. A federated gateway is provided to facilitate secure sharing of the data with the second business application while ensuring compliance with the user-defined permissions.

Further, the concept can include various configurations and functionalities, such as storing the data repository locally on a user device, remotely on a server, or using a hybrid of both; synchronizing the data repository across multiple user devices; and encrypting the data with a cryptographic key controlled by the user. The concept also enables the user to create and manage custom contexts, such as social, location, activity, shopping, and financial contexts, each specifying how data can be used. The concept logs data sharing activities, provides real-time notifications of data access requests, and can anonymize or pseudonymize data before sharing. It also allows for the management of data retention policies, revocation of consent, maintenance of version control, detection of unauthorized access, and automatic data management actions.

Additionally, the concept is configured to curate the data repository based on usage patterns and facilitate the receipt of compensation, rewards, discounts, or promotions from the second business application in exchange for the use of the data.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for managing and controlling personal data within a digital ecosystem.

FIG. 2 shows components of a personal data management sub-system of a client device of the system of FIG. 1.

FIG. 3 shows components of a server device of the system of FIG. 1.

FIG. 4 illustrates an example method for capturing and managing data related to interactions between a user and an artificial intelligence chatbot using the system of FIG. 1.

FIG. 5 illustrates an example method for capturing and managing data related to interactions between a user and a first retail store using the system of FIG. 1.

FIG. 6 shows example physical components of either a host device for the personal data management sub-system or the server device of FIG. 1.

### DETAILED DESCRIPTION

This disclosure relates to managing and controlling personal data within a digital ecosystem. The concept involves providing users with the ability to capture, encrypt, store, and manage their personal data, while controlling how that data is shared and used by various business applications through customizable permissions and a federated gateway.

In the digital age, users engage with numerous systems including business applications and social media platforms, leading to the continuous accumulation of personal data. However, the existing systems often fall short in providing users with the necessary control over how this data is captured, stored, and shared. Users typically have limited visibility into how their personal information is accessed and used by various business entities, raising significant concerns regarding data privacy and security. Moreover, the lack of standardized mechanisms for managing consent and permissions across different platforms exacerbates the risk of unauthorized data sharing and misuse.

This challenge is further compounded by the time it takes for user information to accumulate meaningfully, particularly when the data accurately reflects the user's behavior, preferences, and identity. As users interact with different business applications and social media platforms over time, they generate a rich repository of data that, when properly managed, can offer significant value. However, without the ability to effectively control and apply this accumulated data across multiple platforms, users are often unable to leverage the full potential of their online profiles.

The present concept addresses these issues by empowering users to manage and control their personal data within a digital ecosystem. This enables users to capture, encrypt, and store data related to their interactions with a first business application in a secure repository.

Importantly, it allows users to set and modify consent for data sharing and permissions for data usage with other business applications, ensuring that their data is only shared in accordance with their preferences.

By facilitating the secure sharing of accumulated data across different business applications through a federated gateway, the concept allows businesses to gain a limited, yet valuable, view of the user's online profile. This capability enables businesses to offer experiences that are more accurately tailored to the user's preferences and behaviors, enhancing the overall user experience while maintaining strict compliance with the user's data-sharing permissions.

Moreover, the concept provides a specific, technical solution to a problem unique to digital environments, particularly in the context of user data management across various business applications. Unlike abstract ideas or general methods of organizing human activity, the invention is rooted in the technological challenges of managing personal data within a digital ecosystem. It implements a particular method for securely capturing, encrypting, and storing user data, while allowing controlled sharing of this data with other business applications through a federated gateway. This approach addresses technical problems associated with data privacy, user consent, and multi-platform data sharing, offering an implementation that leverages technology to enhance user control over personal data and improve the user experience across digital interfaces.

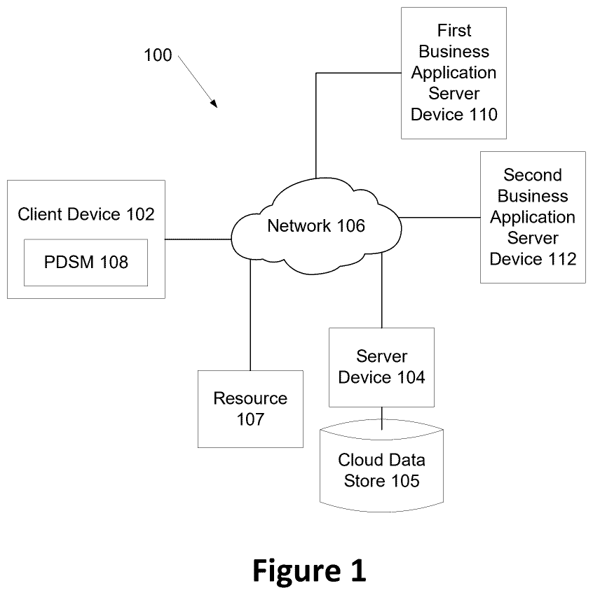

FIG. 1 illustrates an example computer system 100 for managing and controlling personal data within a digital ecosystem. As depicted in FIG. 1, the computer system 100 encompasses a computing environment that includes a client device 102 connected to a server device 104, a first business application server device 110, and a second business application server device 112, via a network 106. Each of these devices may be implemented as one or more computing devices, each equipped with at least one processor and memory. Example computing devices include mobile computers, desktop computers, server computers, or other computing devices or devices such as server farms or cloud computing environments used to generate or manage data within the system.

The client device 102 is a computing device equipped with processors and memory, capable of initiating various tasks related to interacting with one or more business applications over a network and managing and controlling personal data. Client devices can include, but are not limited to, mobile devices such as smartphones and tablets, desktop computers, laptops, and even embedded systems within smart devices. These devices are loaded with a Personal Data Management System (PDSM) 108, which enables the user to capture, encrypt, store, and manage personal data, as well as control how that data is shared with other business applications.

A business application, as referenced herein, broadly encompasses any software interface or platform used by a business or organization to interact with users, collect data, or provide services. The first business application server device 110 and the second business application server device 112 can be configured to support interfaces with different companies'websites or can represent different divisions or groups within a single company.

For example, the first business application server device 110 could support a financial institution's online banking interface, while the second business application server device 112 could support a retail outlet's e-commerce platform. Alternatively, the first business application could support a social media platform where users share content and interact with others, while the second business application could support a retail outlet that uses the social media data to tailor marketing efforts.

In another scenario, both the first and second business applications could represent different divisions within the same financial institution, such as a division for personal banking and another for investment services. While some examples may involve the financial industry, other configurations are possible, and the disclosure is not limited to the financial industry, but is applicable to various fields where secure data management and user interaction are important.

The server device 104, which may be implemented as a single server or a collection of servers within a server farm, possesses computing resources including processors as well as data storage, such as cloud data storage 105. In certain embodiments, the server device 104 may also incorporate resources from a third-party vendor or contracting partner, depicted as resource 107. These resources 107 can include one or more generative pre-trained transformers or other advanced algorithms, as well as subscription software features that enhance the functionality and efficiency of the processes described herein. The server device 104 is responsible for storing and managing large volumes of data, supporting the client device 102 by handling complex processing tasks, and ensuring secure data storage and retrieval.

The network 106 serves as the underlying communication framework, facilitating data exchange and interaction between the devices within the computer system 100. The network 106 enables the reliable and secure transmission of data and commands, supporting real-time interactions between the client device 102, the server device 104, and the first business application server device 110 and second business application server device 112. This network may include various types of communication channels, such as the Internet, intranets, wireless networks, and wired networks, each providing the necessary bandwidth and security features to ensure the integrity and confidentiality of the data being transmitted within the system. The network 106 enables communication across the entire ecosystem, ensuring that users can effectively manage and control their personal data while interacting with different business applications.

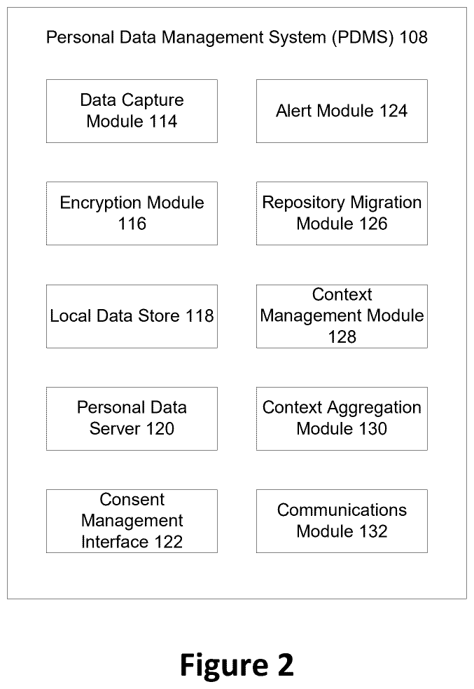

FIG. 2 illustrates components of the PDSM 108 within the client device 102 of the computer system 100 depicted in FIG. 1. The PDSM 108 can be designed to manage and control the user's personal data across various business applications, enabling the user to maintain ownership and control over how their data is stored, shared, and utilized within the digital ecosystem.

The PDSM 108 can be downloaded and installed on the client device 102. This process can be initiated through a software download from an official website, an app store, or a similar distribution platform. During installation, the user may be guided through configuring initial privacy settings, connecting the PDSM 108 to relevant business applications, and integrating the PDSM 108 with any existing user data repositories.

The PDSM 108 can operate either as a standalone application or as an add-in to a web browser, thereafter the PDSM 108 can enable the capture of user data, particularly related to interactions with a first business application. As users navigate various websites and interact with online services, the PDSM 108 can automatically capture and encrypt relevant data, which is then securely stored in the user's data repository. The integration with the browser can ensure that all user interactions with business applications, including form submissions, transactions, and other data exchanges, are monitored and managed according to the user's predefined settings.

The PDSM 108, in conjunction with the server device 104, can collectively function to provide an umbrella user context database designed to manage and secure a user's personal data across multiple business contexts within the digital ecosystem. The umbrella user context database can serve as a repository that aggregates and organizes user data, ensuring that it is handled securely and in accordance with the user's preferences. This database can be implemented using a social networking protocol and model, allowing for the secure and meaningful handling of user data in a manner that respects privacy while enabling data sharing and interaction across different business applications.

The system 100 can allow users to maintain control over their data, providing them with the tools to manage what information is shared with different businesses and how that information is used. Through the umbrella user context database, users can view and modify their data-sharing preferences, revoke permissions, and manage data portability across various platforms. The PDSM 108 can ensure that data is not only secure but also portable, enabling users to migrate their data between different services or applications without compromising privacy or data integrity.

As further depicted in FIG. 2, the PDSM 108 of the client device 102 can include a plurality of components responsible for executing various tasks essential to the management and control of personal data within the system. These components can include a data capture module 114 for capturing user interactions, an encryption module 116 for securing data through encryption and decryption, and a local data store 118 for securely storing sensitive personal information on the user device.

The system 100 can also incorporate a personal data server 120 for managing social networking data locally, a consent management interface 122 for controlling data capture, sharing, and usage permissions, and an alert module 124 for detecting unauthorized access and anomalies in data usage. Additionally, a repository migration module 126 can facilitate the secure migration and version control of the data repository, while a context management module 128 can manage data contexts and custom user settings. A context aggregation module 130 can dynamically aggregate and analyze context-related information, and a communications module 132 can manage secure communication, synchronization, and data sharing across various platforms, including facilitating compensation or rewards from business applications.

The data capture module 114 can be configured to monitor and record all user interactions within the digital ecosystem. The module can capture data generated through a user's interactions with various business applications and social platforms, ensuring that relevant information is logged for further processing and analysis. By capturing a wide range of data points, the data capture module 114 can enable the system to generate insights into user behavior, preferences, and interactions, which can be utilized for personalization, usage tracking, analytics, and supporting various business processes.

In the context of business applications, the data capture module 114 can log user interactions with the first business application, as well as other connected applications. This can include capturing data related to transactions, user preferences, navigation patterns, and any input provided by the user during their interaction with the application. For example, if a user interacts with an online banking application, the data capture module 114 can record details such as login times, transaction histories, and account management activities. The data can be securely logged and made available for further processing to enhance user experience, optimize application performance, and support personalized services.

The data capture module 114 can also extend its functionality to social interactions, capturing data from user activities on social media platforms, messaging applications, and other social networking services. This can include logging posts, messages, likes, shares, and other forms of interaction that occur within the user's social network. By capturing this social interaction data, the module can support the creation of a comprehensive user profile that can be used to tailor content, improve social engagement, and analyze social trends.

In addition to logging data relevant to personalization and analytics, the data capture module 114 can support business processes by capturing detailed records of user interactions. The data can provide valuable insights that can be leveraged for internal analytics, decision-making, and optimizing business strategies. The captured data can be analyzed to identify usage patterns, detect potential issues, and refine services offered to users.

The encryption module 116 can be configured to encrypt and decrypt data stored locally on the user device and to secure the transmission of data when it is sent to an external server. The module can ensure that data remains secure both while it is stored and during its transit across the network. The encryption module 116 can utilize a cryptographic key, which is generated and controlled by the user, to manage the encryption and decryption processes.

When data is stored locally on the user device, the encryption module 116 can apply encryption protocols to protect sensitive information, such as personal identifiers, financial data, and other confidential records. This ensures that even if the data is accessed without authorization, it remains unreadable without the appropriate decryption key. The module can also handle the decryption of this data when access is required by the user or authorized applications.

In scenarios where data needs to be transmitted to an external server, the encryption module 116 can secure the transmission by encrypting the data before it leaves the user device. This encrypted data can then be transmitted over the network, ensuring that it remains protected from interception or unauthorized access during transit. Upon reaching the external server, the data can be decrypted using the appropriate cryptographic methods, assuming the recipient has the necessary decryption key.

The cryptographic key utilized by the encryption module 116 can be generated by the user, allowing them to maintain control over the security of their data. This user-controlled key can ensure that the encryption and decryption processes are managed according to the user's preferences, providing an additional layer of security tailored to the user's specific needs.

The encryption module 116 can be configured to encrypt and decrypt data stored locally on the user device and to secure the transmission of data when it is sent to an external server. The module can ensure that data remains secure both while it is stored and during its transit across the network. The encryption module 116 can utilize a cryptographic key, which is generated and controlled by the user, to manage the encryption and decryption processes. Additionally, the encryption module 116 can employ a secure identity token, a digital representation of a user's identity or data used for authentication and secure access, to control and grant access to personal information.

When data is stored locally on the user device, the encryption module 116 can apply encryption protocols to protect sensitive information, such as personal identifiers, financial data, and other confidential records. This ensures that even if the data is accessed without authorization, it remains unreadable without the appropriate decryption key. The module can also handle the decryption of this data when access is required by the user or authorized applications.

In scenarios where data needs to be transmitted to an external server, the encryption module 116 can secure the transmission by encrypting the data before it leaves the user device. This encrypted data can then be transmitted over the network, ensuring that it remains protected from interception or unauthorized access during transit. Upon reaching the external server, the data can be decrypted using the appropriate cryptographic methods, assuming the recipient has the necessary decryption key.

The cryptographic key utilized by the encryption module 116 can be generated by the user, allowing them to maintain control over the security of their data. This user-controlled key can ensure that the encryption and decryption processes are managed according to the user's preferences, providing an additional layer of security tailored to the user's specific needs.

The secure identity token, in contrast to the cryptographic key, serves as a digital representation of the user's identity or specific data. This token is generated through a tokenization process and can be used for authentication and secure access control, ensuring that only authorized entities can access certain data. Unlike the cryptographic key, which is primarily used for the encryption and decryption of data, the secure identity token is used to uniquely identify a user or piece of data without exposing the actual information. This token can be instrumental in managing access to personal data, allowing the encryption module 116 to grant or restrict access based on the token's validation, thereby enhancing the overall security and privacy of the user's information.

The local data store 118 can be configured as a secure storage area on the user device for sensitive personal data, such as tokenized information and encrypted records. Managed and secured by the encryption module 116, the local data store 118 can ensure that sensitive data remains protected and accessible only to authorized entities. The local data store 118 can store data in a data repository specifically configured to hold personally identifying information, financial account data, and other information designated as sensitive, keeping this data locally on the user device.

In addition to securely storing tokenized and encrypted data, the local data store 118 can also utilize a signed repository mechanism. This signed repository can enhance the security and integrity of the stored data by digitally signing each data entry. A digital signature, created using cryptographic techniques, can verify that the data has not been altered and confirm its source, ensuring that the data remains authentic and reliable.

When data is added to the local data store 118, it can be digitally signed to create a secure and verifiable record. The signing process can involve generating a digital signature using a private key, which can then be associated with the data entry. Upon retrieval, the digital signature can be verified using a corresponding public key, confirming the data's authenticity and integrity. This process can help protect the data from unauthorized modifications and ensure that the source of the data is trustworthy.

The local data store 118 can effectively organize and manage these signed data entries, making it easy to store, retrieve, and verify information securely. By combining the benefits of tokenization, encryption, and digital signatures, the local data store 118 can provide a robust solution for managing and protecting sensitive personal data on the user device.

The personal data server 120 can be configured to act as a local server on the user device, providing a platform for storing and managing social networking data. This component can enable decentralized control over social data, allowing users to manage their information without relying on a centralized platform. By hosting social data locally, the personal data server 120 can offer users greater autonomy and control over their data, ensuring that they can dictate how their information is stored, accessed, and shared.

The personal data server 120 can allow the user to view and manage the data repository, providing functionalities to access, modify, and organize the data. This can include tools for editing social posts, managing contact lists, organizing messages, and setting privacy preferences for various types of social interactions. The ability to directly manage this data locally can empower users to maintain a high level of privacy and security, as the data remains under their control on their own device.

In addition to managing social networking data, the personal data server 120 can facilitate the integration of this data with other components of the PDSM 108. This integration can include the secure storage of data within the local data store 118, the application of encryption protocols via the encryption module 116, and the regulation of data access through the consent management interface 122. By centralizing the management of social data on the user device, the personal data server 120 can provide a user-controlled environment for managing aspects of social networking interactions and data storage.

The consent management interface 122 can be configured to provide users with comprehensive control over what data is captured and how it is used within the digital ecosystem. This component can allow users to set preferences, grant or revoke consent, and view usage logs, giving them the ability to manage their data according to their specific privacy needs and preferences.

Through the consent management interface 122, users can set and modify consent for data sharing and permissions for data usage with a second business application. This can include defining which types of data can be shared, under what conditions, and with which entities. The interface can provide users with a clear and intuitive way to manage these permissions, ensuring that their data is only used in ways that they have explicitly authorized.

The consent management interface 122 can also be configured to provide real-time notifications when a second business application requests access to the user's data. Users can be empowered to grant or deny access in real-time, giving them immediate control over who can access their personal information. Additionally, the interface can offer options to anonymize or pseudonymize data before it is shared with the second business application, protecting the user's identity and ensuring that sensitive information remains secure.

Further, the consent management interface 122 can enable users to define and manage data retention policies. Users can specify how long certain types of data should be stored before being automatically deleted, ensuring that data is not retained longer than necessary. The interface can also allow users to revoke consent for data sharing at any time, and to terminate access for the second business application if needed, providing ongoing control over their data even after initial permissions have been granted.

The alert module 124 can be configured to detect unauthorized access or anomalies in data usage within the digital ecosystem. This component can monitor data interactions and analyze patterns to identify any unusual or potentially malicious activity that may compromise the security or integrity of the user's data.

When the alert module 124 detects unauthorized access attempts or anomalies in how data is being used, it can provide immediate alerts to the user. These alerts can notify the user of the specific nature of the detected issue, allowing them to take appropriate action to secure their data. The alerts can be delivered through various channels, such as on-screen notifications, email alerts, or messages within the PDSM 108 interface.

In addition to providing user alerts, the alert module 124 can be configured to automatically restrict access to the data repository in response to detected threats. This automatic response can help prevent unauthorized entities from accessing or manipulating sensitive data, adding an extra layer of protection. The module can temporarily lock down the data repository, revoke access permissions, or trigger additional security measures until the user can review and address the situation.

The repository migration module 126 can be configured to handle the migration of the user's data repository to other platforms or devices, ensuring that data security, integrity, and the preservation of associated permissions and contexts are maintained throughout the transfer process. This component can facilitate data migration, allowing users to move their data repository without compromising the protection or organization of their information.

During the migration process, the repository migration module 126 can ensure that all data is securely transferred, employing encryption and other security measures to protect the data from unauthorized access or corruption. The module can also maintain the integrity of the data, ensuring that the information remains unchanged and intact as it moves between platforms or devices.

In addition to managing data security and integrity, the repository migration module 126 can preserve the associated permissions and contexts that govern how the data is used and shared. This means that any user-defined settings, such as consent preferences, data sharing permissions, and context-specific rules, are carried over during the migration, ensuring that the user's data management framework remains consistent across different environments.

The repository migration module 126 can also be equipped with version control capabilities, allowing it to maintain a history of changes to the data within the repository. This version control can enable users to revert to previous versions of their data if needed, providing a safety net in case of errors, data corruption, or changes that the user wishes to undo. This functionality can enhance the reliability and flexibility of the data management system, giving users greater control over their information even as it is migrated to new platforms or devices.

The context management module 128 can be configured to manage different data contexts within the digital ecosystem, ensuring that only the appropriate data is shared with business applications based on the user's active context settings. This component can provide users with the ability to tailor data sharing and usage according to specific scenarios or contexts, enhancing both privacy and personalization.

Through the context management module 128, users can create and manage one or more custom contexts that define how their data is used and shared. These contexts can include, but are not limited to, social, location, activity, shopping, and financial contexts. Each context can specify particular rules and conditions under which data can be accessed by business applications, allowing users to exercise precise control over their information.

For example, in a social context, the context management module 128 can manage data related to the user's interactions on social media platforms, determining what content is shared and with whom. In a location context, the module can govern the sharing of GPS or other location-based data, ensuring that this information is only accessible when relevant and necessary. Similarly, in a shopping context, the module can control the sharing of purchase history, brand preferences, and other shopping-related data, tailoring the user's experience while maintaining their privacy.

The context management module 128 can dynamically adjust data sharing based on the user's active context settings, ensuring that business applications only access the data that is pertinent to the current context. This capability can enhance the user's control over their data, allowing for a more secure and customized interaction with various digital services. By managing data contexts effectively, the module can help users navigate the complexities of data sharing in a way that aligns with their personal preferences and privacy requirements.

The context aggregation module 130 can be configured to dynamically aggregate context-related information from various sources within the digital ecosystem, including user interactions, preferences, and active contexts. This component can analyze the data collected from these sources to provide a comprehensive understanding of the user's behavior and data needs, enabling more efficient and personalized data management.

The context aggregation module 130 can analyze user interactions across different contexts, such as social, location, activity, shopping, and financial contexts. By understanding how the user engages with various applications and services, the module can automatically suggest data management actions that align with the user's preferences and the relevance of the data. These suggested actions can include categorization of data into appropriate groups, organization of data for easier access and management, and deletion of redundant or outdated information that no longer serves a purpose.

In addition to suggesting data management actions, the context aggregation module 130 can curate the data repository by identifying and prioritizing data that is most relevant to the user based on usage patterns, context, and historical preferences. This curation process can ensure that the user's data repository remains organized and that the most important and frequently used data is readily accessible. By prioritizing data in this way, the module can help users manage their information more effectively, reducing clutter and enhancing the overall efficiency of their digital environment.

The communications module 132 can be configured to manage secure communication and data synchronization between the user device and external servers within the digital ecosystem. This component can provide a federated gateway to facilitate the secure sharing of data with the second business application, ensuring that all data exchanges comply with the user-defined permissions for data usage. The communications module 132 can support various storage configurations for the data repository, allowing it to be stored locally on the user device, remotely on external servers, or as a hybrid of both, depending on the user's preferences and security requirements.

The communications module 132 can be specifically configured to store sensitive information locally on the user device, while storing the remainder of the data remotely on external servers. This approach can enhance data security by keeping the most critical information under the user's direct control, while still allowing for the flexible storage and management of less sensitive data in remote environments. Additionally, the module can enable synchronization of at least a portion of the data repository across multiple user devices, ensuring that the user's data is consistent and up to date, regardless of the device being used.

As part of its functionality, the communications module 132 can log all data sharing activities, providing a comprehensive record for user review. This logging capability can allow users to monitor how their data is being shared and used, ensuring transparency and accountability in data exchanges. The module can also facilitate the receipt of compensation, rewards, discounts, or promotions from the second business application in exchange for the use of the user's data, adding value to the user's participation in the digital ecosystem.

The communications module 132 can serve as a key component of a federation mechanism within the umbrella user context database, enabling multiple independent entities or components to work together in a coordinated manner while maintaining their autonomy. In this role, the communications module can facilitate the synchronization, management, and interoperability of data across various digital context repositories and user contexts. This federation mechanism can ensure that data is kept up-to-date and consistent across repositories, managing and regulating data flow to adhere to privacy and security policies. Furthermore, it can enable different contexts and repositories to communicate and interact, allowing users to manage and share their data securely and efficiently across multiple platforms and business contexts while retaining control over their personal information.

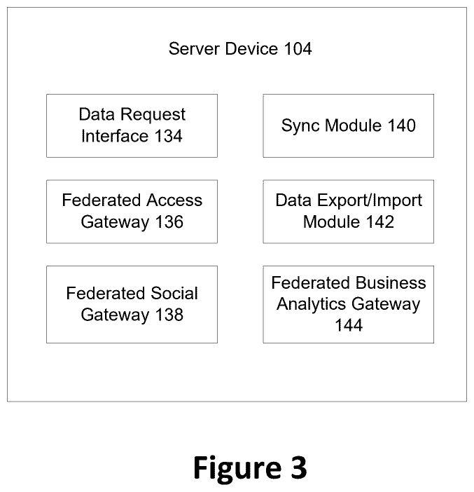

FIG. 3 illustrates components of the server device 104 within the computer system 100 depicted in FIG. 1. The server device 104 can be configured to communicate with the PDSM 108, and together they can collectively function to provide an umbrella user context database designed to manage and secure a user's personal data across multiple business contexts within the digital ecosystem.

The server device 104 can operate as a centralized platform that supports the PDSM 108 by handling complex data processing, storage, and management tasks. This includes securely storing aggregated user data, managing data synchronization across different devices, and facilitating secure data sharing between the user's PDSM 108 and various business applications. The server device 104 can also integrate with third-party services, enabling enhanced functionality such as data analysis, AI-driven recommendations, and additional security measures.

The server device 104 can serve as a vital component in the implementation of the umbrella user context database, where it aggregates and organizes user data from various sources, ensuring that the data is managed according to the user's preferences and privacy settings. The server device 104 can also support the deployment of social networking protocols and models that allow for the secure and meaningful handling of user data, enabling data sharing and interaction across different business applications while respecting user privacy.

The communication between the server device 104 and the PDSM 108 can allow users to maintain control over their data, providing them with the tools to manage what information is shared with different businesses and how that information is used. Through the umbrella user context database, users can view and modify their data-sharing preferences, revoke permissions, and manage data portability across various platforms. The server device 104 can ensure that data is not only secure but also portable, enabling users to migrate their data between different services or applications without compromising privacy or data integrity.

As further depicted in FIG. 3, the server device 104 can include a plurality of components responsible for supporting the management and control of personal data within the computer system 100. These components can include a federated social gateway 138 for managing social interactions across different platforms, a federated access gateway 136 for controlling access to the user's data across multiple business applications, and a sync module 140 for securely aggregating and synchronizing data received from various sources.

The server device 104 can also incorporate a federated business analytics gateway 144, which can facilitate the analysis of user data across different business contexts, and a federated portability gateway, which can manage the secure transfer of user data between platforms, ensuring data portability and integrity. Additionally, a data export/import module 142 can handle the transfer of data in and out of the system, allowing for data integration with external services. Finally, a data request interface 134 can provide a secure and controlled method for external entities to request access to the user's data, ensuring that all data interactions comply with user-defined permissions and privacy settings.

As further depicted in FIG. 3, the server device 104 can include a plurality of components responsible for supporting the management and control of personal data within the computer system 100. These components can include a data request interface 134, which serves as the entry point for business applications to interact with the user's data stored on the external server. The federated access gateway 136 can act as a secure access point, allowing business applications to request and retrieve user data based on user-defined permissions and authorization, while also managing the secure exchange of data in compliance with the user's consent and context rules.

The server device 104 can also incorporate a federated social gateway 138, which enables integration with existing social networking platforms while ensuring that the user maintains control over their data. Additionally, a sync module 140 can ensure that data between the user device and the cloud data store is kept in sync, handling updates, conflict resolution, and maintaining data consistency across all user devices. Finally, a data export/import module 142 can facilitate the secure export and import of user data, ensuring operation of the migration process to ensure that data remains consistent across different platforms.

The data request interface 134 can be configured to serve as the entry point through which business applications interact with the user's data stored on the external server. This component can handle requests from business applications to access, analyze, or utilize the user's data in a manner that aligns with the permissions and contexts defined by the user. The data request interface 134 can authenticate each request to ensure that only authorized applications are granted access, thereby maintaining the security and privacy of the user's data.

Once a request is authenticated, the data request interface 134 can log the details of the interaction, providing a comprehensive record that the user can review. This logging capability can allow users to monitor how their data is being accessed and used, ensuring transparency and accountability in data exchanges. The interface can also empower the user to grant or deny access to specific pieces of data, offering granular control over which information is shared with different business applications.

The federated access gateway 136 can be configured as a secure access point that allows business applications to request and retrieve user data from the cloud data store based on user-defined permissions and authorization. This gateway can manage the secure exchange of data with business applications, ensuring that all interactions comply with the user's consent and context rules.

When a business application requires access to the user's data, it can send a request through the federated access gateway 136. The gateway can act as a mediator, processing the request and determining whether it aligns with the permissions and contexts specified by the user. This ensures that the business application only accesses data that the user has explicitly permitted.

The federated access gateway 136 can also oversee the secure transfer of data, maintaining the integrity and confidentiality of the user's information during the exchange. By enforcing the user's preferences and context settings, the gateway can ensure that all data exchanges respect the user's privacy and security requirements. This capability allows users to have confidence that their data is being accessed and used in a manner that aligns with their expectations and consent.

The federated social gateway 138 can be configured as a component of the server device 104, enabling integration with existing social networking platforms if desired. This gateway can allow the user to interact with external social networks while maintaining full control over their data.

When the user wishes to share content or engage with social networking platforms, the federated social gateway 138 can facilitate this connection. It can manage the flow of data between the user's environment and the external platforms, ensuring that any shared information adheres to the user's predefined permissions and privacy settings.

The federated social gateway 138 can ensure that the user's data remains under their control throughout the interaction, even when integrating with external platforms. This capability allows users to connect with social networks while safeguarding their personal information and maintaining their autonomy over how their data is shared and utilized in these external environments.

The sync module 140 can be configured to ensure that data between the user device and the cloud data store is kept in sync. This component can handle updates, manage conflict resolution, and ensure that the user's data remains consistent across all their devices.

The sync module 140 can continuously monitor data changes on both the user device and the cloud data store, ensuring that any modifications made in one environment are accurately reflected in the other. This synchronization process can help maintain data integrity, preventing discrepancies or data loss across different devices and environments.

In cases where conflicting changes are detected, the sync module 140 can implement conflict resolution strategies to determine which version of the data should be retained, ensuring that the most accurate and relevant information is preserved. By keeping the local data store and cloud data store aligned, the sync module 140 can maintain a consistent and reliable data experience for the user, regardless of which device they are using.

The data export/import module 142 can be configured to facilitate the secure export and import of user data, ensuring that the migration process is completed and the data remains consistent across different platforms. This component can enable the movement of data between systems while maintaining data integrity and consistency throughout the transfer.

When data needs to be exported from one platform and imported into another, the data export/import module 142 can manage the entire process, ensuring that all data is securely transferred without loss or corruption. The module can handle various data formats and structures, converting and aligning the data as necessary to ensure compatibility with the target platform.

The data export/import module 142 can also implement security measures during the transfer, such as encryption and authentication, to protect the data from unauthorized access or tampering. By maintaining strict control over the export and import process, the module can ensure that the user's data remains intact and reliable, regardless of the platforms involved.

The federated business analytics gateway 144, can be configured to manage and analyze user data across different business contexts within the digital ecosystem. This gateway can ensure that only the appropriate data is shared with business applications, tailored to the user's active context settings, thereby enhancing both privacy and personalization.

Through the federated business analytics gateway 144, users can define and manage multiple custom contexts that dictate how their data is utilized and shared across various business applications. These contexts can include social, location, activity, shopping, and financial scenarios, among others. Each context can establish specific rules and conditions under which data can be accessed, allowing users to maintain precise control over their information.

For instance, in a social context, the gateway can manage data related to the user's interactions on social media platforms, determining what content is shared and with whom. In a location context, it can govern the sharing of GPS or other location-based data, ensuring that such information is only accessible when relevant and necessary. Similarly, in a shopping context, the gateway can regulate the sharing of purchase history, brand preferences, and other shopping-related data, thus tailoring the user's experience while maintaining their privacy.

The federated business analytics gateway 144 can dynamically adjust data sharing based on the user's active context settings, ensuring that business applications only access data pertinent to the current context. This capability enhances user control over their data, allowing for a secure and customized interaction with various digital services. By effectively managing data contexts, the gateway helps users navigate the complexities of data sharing in alignment with their personal preferences and privacy requirements.

In addition, the federated business analytics gateway 144 can be configured to dynamically aggregate context-related information from various sources within the digital ecosystem, including user interactions, preferences, and active contexts. This aggregation process can provide a comprehensive understanding of the user's behavior and data needs, enabling more efficient and personalized data management.

By analyzing user interactions across different contexts—such as social, location, activity, shopping, and financial—the gateway can automatically suggest data management actions that align with the user's preferences and the relevance of the data. These suggested actions might include categorizing data into appropriate groups, organizing data for easier access and management, and deleting redundant or outdated information that no longer serves a purpose.

Furthermore, the federated business analytics gateway 144 can curate the data repository by identifying and prioritizing the most relevant data based on usage patterns, context, and historical preferences. This curation ensures that the user's data repository remains organized, with the most important and frequently used data readily accessible. By prioritizing data in this manner, the gateway helps users manage their information more effectively, reducing clutter and enhancing the overall efficiency of their digital environment.

In certain embodiments, the server device 104 may also incorporate resources from a third-party vendor or contracting partner, depicted as resource 107. These resources 107 can include one or more generative pre-trained transformers or other advanced algorithms, as well as subscription software features that enhance the functionality and efficiency of the processes described herein.

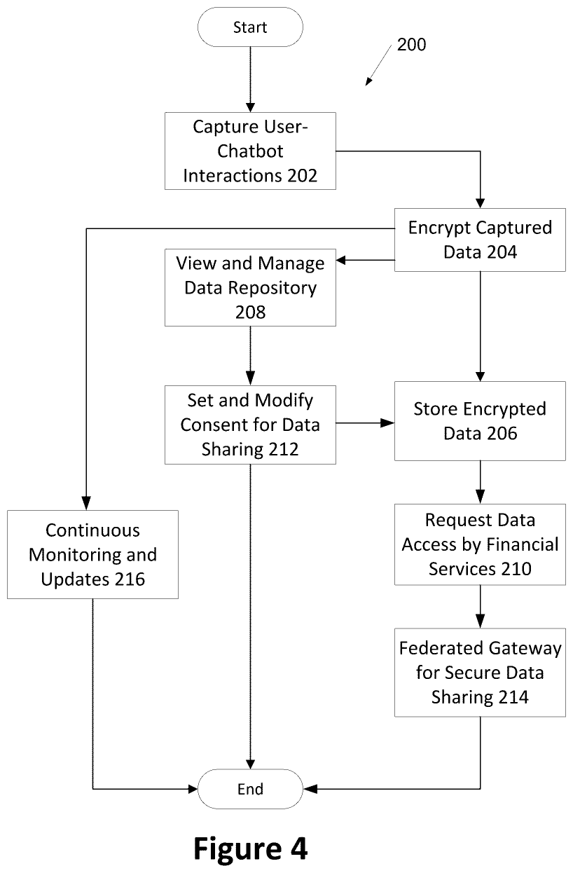

Referring to FIG. 4, an exemplary method 200 is illustrated for capturing and managing data related to interactions between a user and an artificial intelligence chatbot, implemented by the computer system 100. This method 200 comprises a sequence of steps and can be implemented by the computer system 100. For instance, the server device 104 is configured to interact with the client device 102, the data repository (e.g., cloud data storage 105 etc.,), and a financial services enterprise via the network 106 to facilitate the execution of the steps outlined in method 200.

The method can be initiated with step 202, where the system captures interactions between the user and the AI chatbot. This data can include text conversations, user inputs, and the AI's responses, all of which are collected in real-time as the user engages with the chatbot.

Following the capture of these interactions, step 204 involves encrypting the captured data using a cryptographic key that is generated and controlled by the user. The encryption process ensures that the data remains secure and inaccessible to unauthorized parties during storage and transmission.

At step 206, the encrypted data is stored in a data repository within the user's device or the cloud. The data repository can be configured to securely manage the stored information, maintaining its integrity and confidentiality. The system can then proceed to step 208, where the user is enabled to view and manage the data repository. This step allows the user to access, modify, and organize the stored data, providing full control over how the data is managed and utilized. The user interface can offer options to categorize interactions, delete outdated data, or update encryption settings as needed.

Step 210 describes how a financial services enterprise can request access to the data capturing interactions between the user and the AI chatbot. The enterprise can send a request through the system, specifying the intended use of the data, such as tailoring product and service offerings to the user. The system can then present this request to the user for review.

In step 212, the user is provided with the ability to set and modify consent for data sharing and permissions for data usage with the financial services enterprise. The system can offer a consent management interface where the user can specify what data can be shared, under what conditions, and for how long. The user can grant or revoke consent at any time, ensuring that their preferences are always respected.

Step 214 involves the provision of a federated gateway by the system to facilitate the secure sharing of the data with the financial services enterprise. The federated gateway acts as a secure mediator, ensuring that the data is transferred in compliance with the permissions and usage rules established by the user. The gateway can enforce data usage policies, anonymize data if necessary, and log all data-sharing activities to maintain transparency and accountability.

Finally, step 216 describes how the system can continuously monitor and update the data-sharing settings to reflect any changes made by the user or updates in privacy regulations. The federated gateway can adapt to these changes, ensuring that all future data exchanges remain compliant with the user's preferences and the latest security standards. This method ensures that user interactions with the AI chatbot are securely captured, managed, and shared in a manner that prioritizes user control and data privacy.

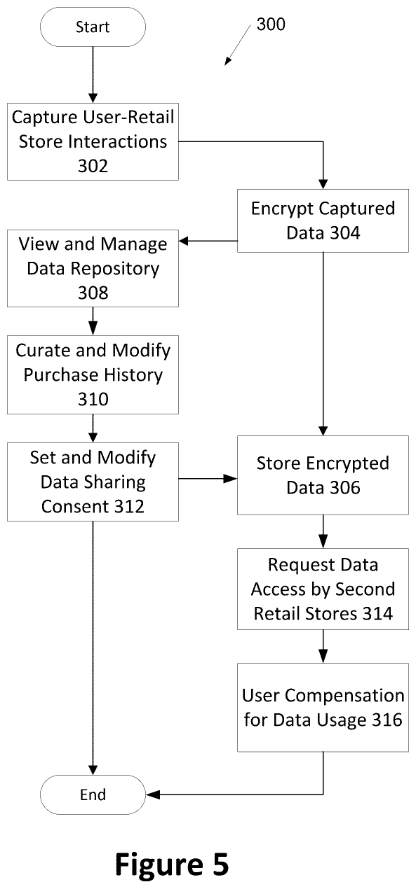

Referring to FIG. 5, an exemplary method 300 is illustrated for capturing and managing data related to interactions between a user and a first retail store, implemented by the computer system 100. This method 300 comprises a sequence of steps and can be implemented by the computer system 100. For instance, the server device 104 is configured to interact with the client device 102, the data repository (e.g., cloud data storage 105, etc.), and one or more second retail stores via the network 106 to facilitate the execution of the steps outlined in method 300.

The method can be initiated with step 302, where the system captures data related to the interactions between the user and the first retail store. This data can include purchase history, product preferences, browsing behavior, and any user inputs or actions taken during the interaction. The data is collected in real-time as the user engages with the retail store, providing a comprehensive record of the user's activities.

Following the capture of these interactions, step 304 involves encrypting the captured data using a cryptographic key that is generated and controlled by the user. The encryption process ensures that the data remains secure and inaccessible to unauthorized parties during storage and transmission, protecting the user's sensitive information.

At step 306, the encrypted data is stored in a data repository within the user's device or the cloud. The data repository can be configured to securely manage the stored information, maintaining its integrity and confidentiality. The system can then proceed to step 308, where the user is enabled to view and manage the data repository. This step allows the user to access, modify, and organize the stored data, providing full control over how the data is managed and utilized. The user interface can offer options to categorize purchases, delete outdated records, or update encryption settings as needed.

Step 310 describes how the user can elect to modify their data by curating it to provide a more accurate reflection of their purchase history. The system can enable the user to review and edit the captured data, allowing them to add, remove, or correct entries to ensure that the data accurately represents their buying patterns and preferences. This curated data can then be stored back into the repository, ensuring that any future data usage or analysis is based on accurate and up-to-date information.

In step 312, the user is provided with the ability to set and modify consent for data sharing and permissions with second business applications. The system can offer a consent management interface where the user can specify what data can be shared, with whom, and under what conditions. The user can also set time limits for data sharing and revoke consent at any time, ensuring that their preferences are always respected.

Step 314 involves one or more second retail stores requesting access to the user's curated data. These requests can be made to tailor sales or promotional material based on the user's purchase history. The system can present these requests to the user for approval, allowing them to decide which stores can access their data and under what terms.

Finally, step 316 describes how the user can be effectively compensated for the use of their data through tailored sales or promotional materials, discounts, or other benefits provided by the second retail stores. The system can facilitate these transactions, ensuring that the user receives tangible benefits in exchange for sharing their data. This compensation can be aligned with the user's purchase history, providing personalized offers and rewards that enhance the user's shopping experience.

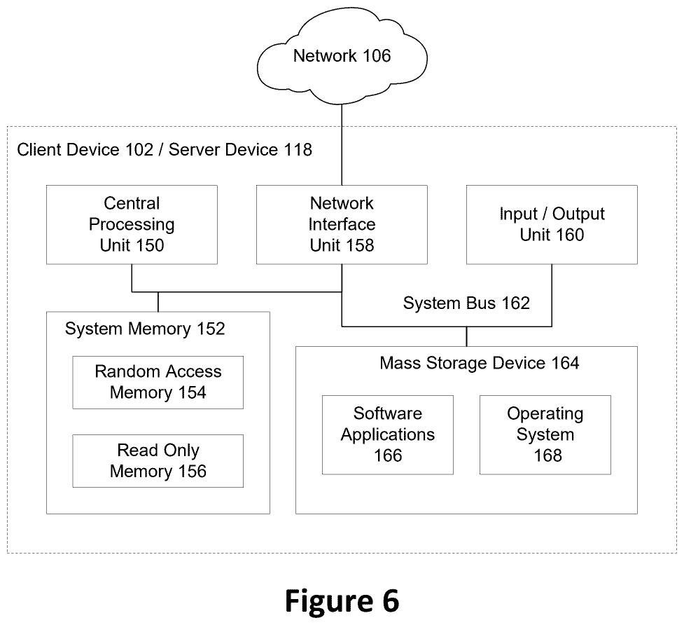

As illustrated in the embodiment of FIG. 6, the example host device to the personal data management sub-system (such as the client device 102, etc.) or server device 104, which provides the functionality described herein, can include at least one central processing unit (“CPU”) 150, a system memory 152, and a system bus 162 that couples the system memory 152 to the CPU 150. The system memory 152 includes a random-access memory (“RAM”) 154 and a read-only memory (“ROM”) 156. A basic input/output system containing the basic routines that help transfer information between elements within the host device or server device 104, such as during startup, is stored in the ROM 156. The host device or server device 104 further includes a mass storage device 164. The mass storage device 164 can store software instructions and data. A central processing unit, system memory, and mass storage device similar to that shown can also be included in the other computing devices disclosed herein.

The mass storage device 164 is connected to the CPU 150 through a mass storage controller (not shown) connected to the system bus 162. The mass storage device 164 and its associated computer-readable data storage media provide non-volatile, non-transitory storage for the host device or server device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the host device or server device 104.

According to various embodiments of the invention, the host device or server device 104 may operate in a networked environment using logical connections to remote network devices through network 106, such as a wireless network, the Internet, or another type of network. The host device or server device 104 may connect to network 106 through a network interface unit 158 connected to the system bus 162. It should be appreciated that the network interface unit 158 may also be utilized to connect to other types of networks and remote computing systems. The host device or server device 104 also includes an input/output controller 160 for receiving and processing input from a number of other devices, including a touch user interface display screen or another type of input device. Similarly, the input/output controller 160 may provide output to a touch user interface display screen or other output devices.

As mentioned briefly above, the mass storage device 164 and the RAM 154 of the host device or server device 104 can store software instructions and data. The software instructions include an operating system 168 suitable for controlling the operation of the host device or server device 104. The mass storage device 164 and/or the RAM 154 also store software instructions and applications 166, that when executed by the CPU 150, cause the host device or server device 104 to provide the functionality discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for managing personal data within a digital ecosystem, the computer system comprising:
one or more processors; and
non-transitory computer-readable storage media encoding instructions which, when executed by the one or more processors, cause the computer system to:
capture data related to interactions of a user with a first business application;
encrypt the data and store the data in a data repository;
enable the user to view and manage the data repository, including an ability to access, modify, and organize the data;
allow the user to set and modify consent for data sharing and permissions for data usage with a second business application;
provide a federated gateway to facilitate secure sharing of the data with the second business application, while complying with the permissions for data usage with the second business application.

2. The computer system of claim 1, wherein the data repository is stored on at least one of: locally on a user device, remotely on a server, or a hybrid of both local and remote storage.

3. The computer system of claim 2, wherein the computer system is configured to store personally identifying information, financial account data and other information designated as sensitive, locally on the user device, while a remainder of the data is stored remotely on the server.

4. The computer system of claim 1, wherein the computer system is configured to enable synchronization of at least a portion of the data repository across multiple user devices.

5. The computer system of claim 1, wherein encryption of the data uses a cryptographic key that is generated and controlled by the user.

6. The computer system of claim 1, wherein the computer system further enables the user to create and manage one or more custom contexts, including at least one of to:
specify social context permissions under which data captured from social media platforms, messaging applications, and other social networking services can be used;
specify location context permissions under which location data, including real-time Global Positioning System data and location history, can be used;
specify activity context permissions under which data related to physical activity or device usage, can be used;
specify shopping context permissions under which data related to shopping habits, including at least one of purchase history, brand preferences, searches for products and services, and wishlists, can be used; and
specify financial context permissions under which financial data, including spending habits, and budgeting data, can be used.

7. The computer system of claim 1, wherein the federated gateway is configured to log all data sharing activities, enabling the user to review the data that has been shared with the second business application.

8. The computer system of claim 1, wherein the computer system is configured provide a notification to the user when a second business application requests access to the data, allowing the user to grant or deny access in real-time.

9. The computer system of claim 1, wherein the computer system is configured to anonymize or pseudonymize the data before the data is shared with the second business application, to protect an identity of the user while allowing the data to be used.

10. The computer system of claim 1, wherein the computer system enables the user to define and manage data retention policies, including specifying a duration for which different types of data are stored before being automatically deletion.

11. The computer system of claim 1, wherein the computer system enables the user to revoke consent for data sharing with the second business application, causing the computer system to terminate access to the data by the second business application.

12. The computer system of claim 1, wherein the computer system is configured to maintain a version control of the data in the data repository, enabling reversion to a previous version of the data.

13. The computer system of claim 1, wherein the computer system is configured to detect unauthorized access or anomalies in data usage, and at least one of provide an alert to the user or automatically restrict access to the data repository.

14. The computer system of claim 1, wherein the computer system is configured to analyze user interactions and automatically suggest data management actions, including at least one of categorization, organization, and deletion of redundant or outdated data.

15. The computer system of claim 1, wherein the computer system is configured to curate the data repository by identifying and prioritizing data for the user based on usage patterns, context, and historical preferences.

16. The computer system of claim 1, wherein the computer system is configured to facilitate receipt of at least one of compensation, rewards, discounts, or promotions from the second business application, in exchange for the use of the data.

17. A method for managing and controlling personal data within a digital ecosystem, the method comprising:
capturing data related to interactions of a user with a first business application;
encrypting the data and storing the data in a data repository;
enabling the user to view and manage the data repository, including providing an ability to access, modify, and organize the data;
allowing the user to set and modify consent for data sharing and permissions for data usage with a second business application; and
providing a federated gateway to facilitate secure sharing of the data with the second business application, while ensuring compliance with the permissions for data usage with the second business application.

18. The method of claim 17, further comprising enabling the user to define and manage data retention policies, including specifying a duration for which different types of data are stored before being automatically deleted.

19. The method of claim 17, further comprising analyzing user interactions and automatically suggesting data management actions, including at least one of categorization, organization, and deletion of redundant or outdated data.

20. The method of claim 17, further comprising facilitating receipt of at least one of compensation, rewards, discounts, or promotions from the second business application, in exchange for the use of the data.
